(19) United States
(12) Patent Application Publication
(10) Pub. No.: US 2024/0319540 A1
(43) Pub. Date: Sep. 26, 2024

(54) LIQUID CRYSTAL ALIGNMENT LAYER, LIQUID CRYSTAL MOLECULE AND LIQUID CRYSTAL DISPLAY PANEL

(71) Applicant: Guangzhou China Star Optoelectronics Semiconductor Display Technology Co., LTd., Guangzhou (CN)

(72) Inventor: Shiqing LI, Guangzhou (CN)

(73) Assignee: Guangzhou China Star Optoelectronics Semiconductor Display Technology Co., LTd., Guangzhou (CN)

(21) Appl. No.: 18/523,794

(22) Filed: Nov. 29, 2023

(30) Foreign Application Priority Data
Mar. 21, 2023 (CN) 202310283303.8

(51) Int. Cl. G02F 1/1337

(52) U.S. Cl. CPC G02F 1/133711; G02F 1/133723

(57) ABSTRACT

A liquid crystal alignment layer, a liquid crystal molecule, and a liquid crystal display panel. The liquid crystal alignment layer includes a first sub-alignment layer and a second sub-alignment layer disposed on the first sub-alignment layer and on a side adjacent to a liquid crystal layer. A dielectric constant of the second sub-alignment layer is greater than a dielectric constant of the first sub-alignment layer.

### CROSS-REFERENCE TO RELATED APPLICATION

This application claims priority to and the benefit of Chinese Patent Application No. 202310283303.8, filed on Mar. 21, 2023, the disclosure of which is incorporated herein by reference in its entirety.

### TECHNICAL FIELD

The present disclosure relates to the field of alignment of liquid crystal display panels, and more particularly, to a liquid crystal alignment layer, a liquid crystal molecule, and a liquid crystal display panel.

### BACKGROUND

With the development of manufacturing technologies of display panels, higher requirements have been put forward both for display effect and overall performance of display panels and display devices.

Conventional liquid crystal displays (also known as LCDs) have the advantages of low cost and high definition. Therefore, liquid crystal displays are widely used, and are particularly widely used for outdoor display. As demands for use further increase, demands for the performance of liquid crystal display panels also increase. When a liquid crystal display panel is displaying, under the action of a high-frequency AC battery, an electric field of a certain strength will be formed between a liquid crystal alignment layer and a corresponding liquid crystal layer, thereby driving the liquid crystals to rotate by a certain angle and obtaining a desired display effect. However, in related art, when a liquid crystal display panel displays, the above liquid crystal alignment layer and liquid crystal layer often fail to synchronously respond to variations of an external electric field during operation, thereby causing a lag and a problem of poor display such as a decrease in display definition, picture flutter, and screen flicker. Meanwhile, with the popularization of products with high refresh rate, variations of the electric field are further amplified, thereby preventing further improvements of liquid crystal display panels in terms of the display effect.

In view of the foregoing, when the liquid crystal display panel provided in the related art displays, working effects of its liquid crystal alignment layer and the liquid crystal layer are poor, and problems such as poor display are prone to occur, thereby reducing the display effect and overall performance of the display panel.

### SUMMARY

Embodiments of the present disclosure provides a liquid crystal alignment layer, a liquid crystal molecule, and a liquid crystal display panel.

In an aspect of the present disclosure, provided is a liquid crystal alignment layer including a first sub-alignment layer; a second sub-alignment layer disposed on the first sub-alignment layer and on a side adjacent to a liquid crystal layer; where a dielectric constant of the second sub-alignment layer is greater than a dielectric constant of the first sub-alignment layer.

In another aspect of the present disclosure, provided is a liquid crystal molecule, a structural formula of the liquid crystal molecule including any one of

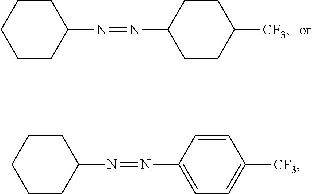 [SMILES: FC(F)(F)C1CCC(N=NC2CCCCC2)CC1 ; FC(F)(F)c1ccc(N=NC2CCCCC2)cc1]

In yet another aspect of the present disclosure, provided is a liquid crystal display panel including a first substrate; a liquid crystal layer including a plurality of liquid crystal molecules, the liquid crystal layer disposed on the first substrate; and a second substrate disposed on the liquid crystal layer; where the liquid crystal display panel further includes liquid crystal alignment layers disposed on a side of the liquid crystal layer adjacent to the first substrate and adjacent to the second substrate, each of the plurality of liquid crystal molecules having a structural formula including any one of

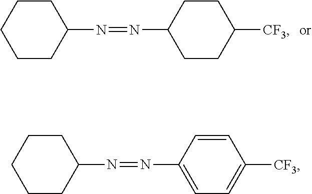 [SMILES: FC(F)(F)C1CCC(N=NC2CCCCC2)CC1 ; FC(F)(F)c1ccc(N=NC2CCCCC2)cc1]

or each of the liquid crystal alignment layers including a first sub-alignment layer; a second sub-alignment layer disposed on the first sub-alignment layer and on a side adjacent to the liquid crystal layer; where a dielectric constant of the second sub-alignment layer is greater than a dielectric constant of the first sub-alignment layer.

### BRIEF DESCRIPTION OF THE DRAWINGS

In order that the embodiments or technical solutions in the related art may be described more clearly, the following will provide a brief introduction to the accompanying drawings required in the description of the embodiments or the related art. It will be apparent that the accompanying drawings related to the description below are merely some of the embodiments of the present disclosure. For those of ordinary skill in the art, other drawings can be obtained based on these accompanying drawings without exerting creative efforts.

FIG. 1 is a schematic structural diagram showing films/layers of a liquid crystal display panel provided in embodiments of the present disclosure;

FIG. 2 is a schematic structural diagram of an alignment layer of the liquid crystal display panel provided in embodiments of the present disclosure.

### DETAILED DESCRIPTION

In conjunction with the accompanying drawings in the embodiments of the present disclosure, the following disclosure provides different implementations or examples to implement different structures of the present disclosure. In order to simplify the present disclosure, components and arrangements of specific examples are described below. Furthermore, the present disclosure provides examples of various specific processes and materials so that those of ordinary skill in the art can be aware of the application of other processes. All other embodiments obtained by those skilled in the art without exerting creative efforts are within the scope of the present disclosure.

In the description of the present disclosure, it is to be understood that the azimuth or positional relationship indicated by the terms “center”, “longitudinal”, “transverse”, “length”, “width”, “thickness”, “up”, “down”, “front”, “back”, “left”, “right”, “vertical”, “horizontal”, “top”, “bottom”, “inner”, “outer”, “clockwise”, “counterclockwise”, and the like, is based on the azimuth or positional relationship shown in the accompanying drawings. These terms are intended to merely facilitate description of the present disclosure and to simplify the description, and is not intended to indicate or imply that the device or element referred to must have a particular azimuth, or must be constructed and operated in a particular azimuth, and therefore is not to be construed as limiting the present disclosure. Furthermore, the terms “first” and “second” are used for descriptive purposes only and are not to be construed as indicating or implying relative importance or implying the number of indicated technical features.

With the continuous development of manufacturing technologies of display panels, higher requirements have been put forward both for overall performance and display effect of liquid crystal display panels and display devices.

In the related art, for high-frequency or even ultra-high-frequency display products, their panels have a high refresh rate, thereby satisfying users' demands for use. However, on the basis of existing products, when the refresh rate of a panel is high, the alignment layer and liquid crystal layer in the liquid crystal panel are unable to change synchronously with an electric field varying at high frequency, resulting in a problem of screen tearing in the display panel which is not conducive to further improvements of the overall performance of the panel.

Embodiments of the present disclosure provide a liquid crystal alignment layer, a liquid crystal molecule, and a liquid crystal display panel, so as to effectively improve a problem that the display effect of a panel is not ideal under a high-frequency working condition, and to improve the overall performance of the panel.

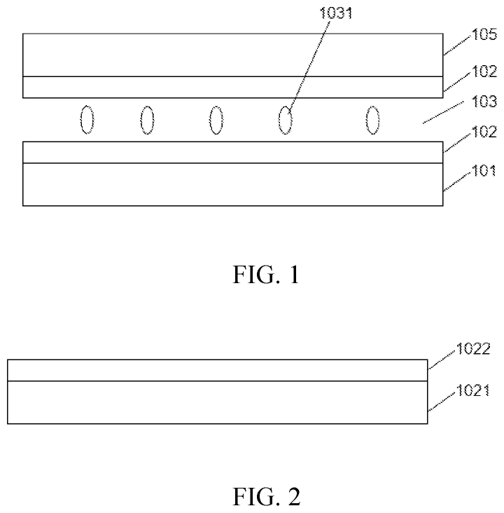

As shown in FIG. 1, FIG. 1 is a schematic structural diagram showing films/layers of a liquid crystal display panel provided in embodiments of the present disclosure. Specifically, the liquid crystal display panel includes a first substrate 101, liquid crystal alignment layers 102, a liquid crystal layer 103, and a second substrate 105. The first substrate 101 may be an array substrate in which a plurality of thin-film transistors is provided. When the display panel operates normally, a driving control signal is supplied through the array substrate. Meanwhile, the second substrate 105 may be a color-film substrate, and a pair of the array substrate and the color-film substrate constitutes a cell, forming the liquid crystal display panel in the embodiments of the present disclosure.

Further, the liquid crystal alignment layers 102 are provided on both sides of the liquid crystal layer 103, for example, one of the liquid crystal alignment layers 102 is provided on a side of the liquid crystal layer 103 adjacent to the first substrate 101, and another one of the liquid crystal alignment layers 102 is provided on another side of the liquid crystal layer 103 adjacent to the second substrate 105. When the display panel operates normally, the liquid crystal alignment layers 102 are configured to change angles of liquid crystal molecules in the liquid crystal layer 103 and to ensure that they change at a frequency synchronized with a varying electric field under a high-frequency condition, thereby effectively improving the display effect of the display panel under the high-frequency condition.

In the embodiments of the present disclosure, the liquid crystal layer 103 is disposed between the array substrate and the color-film substrate, and liquid crystal molecules 1031 are disposed in the liquid crystal layer 103. The above liquid crystal molecules 1031 may undergo varying degrees of rotation according to different control signals, such as high-frequency control signals, thereby obtaining a superior display effect.

Further, the liquid crystal alignment layers in the liquid crystal display panel and the liquid crystal molecules in the liquid crystal layer provided in the embodiments of the present disclosure are of structures or materials provided in the embodiments of the present disclosure, thereby ensuring a good display effect.

As shown in FIG. 2, FIG. 2 is a schematic structural diagram of an alignment layer of the liquid crystal display panel provided in embodiments of the present disclosure. Specifically, the liquid crystal alignment layer 102 may include a double-layer structure. For example, the liquid crystal alignment layer includes a first sub-alignment layer 1021 and a second sub-alignment layer 1022. The second sub-alignment layer 1022 is disposed on the first sub-alignment layer 1021 while the liquid crystal layer is disposed on the second sub-alignment layer 1022. Thus, a stacked structure of two films/layers is formed, constituting the liquid crystal alignment layer 102 in the embodiments of the present disclosure.

In the embodiments of the present disclosure, when the above first sub-alignment layer 1021 and the second sub-alignment layer 1022 are provided, the first sub-alignment layer 1021 and the second sub-alignment layer 1022 have different dielectric constants. By setting different dielectric constants and thus adapting to an electric field varying at high frequency, synchronous changes are achieved and the display effect thereof is ensured.

Specifically, when the above films are provided, the dielectric constant corresponding to the second sub-alignment layer 1022 is greater than the dielectric constant corresponding to the first sub-alignment layer 1021. By providing sub-alignment layers of different dielectric constants, the liquid crystal alignment layer can better adapt to the electric field varying at high frequency and achieve the effect of synchronous changes.

Specifically, the dielectric constant of the first sub-alignment layer 1021 is set to 2.0-2.5, while the dielectric constant of the second sub-alignment layer 1022 is set to 2.8-4.5. Optionally, the dielectric constant of the first sub-alignment layer 1021 is set to any of 2.2, 2.3, or 2.4, while the dielectric constant of the second sub-alignment layer 1022 is set to any of 2.8, 3.2, 3.6, 4.3.

Further, in the embodiments of the present disclosure, for better alignment between two different sub-alignment layers, a difference between the dielectric constant of the second sub-alignment layer 1022 and the dielectric constant of the first sub-alignment layer 1021 may be greater than 0.3 and less than 1.2. At this point, the dielectric constant of the first sub-alignment layer 1021 is set to 2.2, and the dielectric constant of the second sub-alignment layer 1022 is set to 3. By providing a specific difference, it is ensured that the two sub-alignment layers cooperate with each other and that the response effect under a high-frequency electric field is guaranteed.

Further, in the embodiments of the present disclosure, when the above different sub-alignment layers are provided, the first sub-alignment layer 1021 and the second sub-alignment layer 1022 are each illustrated by using one of polyimide or polyimide acid as an example. That is, body materials of the first sub-alignment layer and the second sub-alignment layer are polyimide or polyimide acid materials, and the polyimide or polyimide acid may be any of those commercially available to realize the alignment feature, and details are not repeated herein.

Specifically, in the first sub-alignment layer 1021, it also includes a fluorine element. Since the first sub-alignment layer 1021 is provided at the bottom, when the panel operates normally, it mainly functions to transport or release charges formed in the liquid crystal alignment layer, so that the liquid crystal alignment layer may change in synchronization with the varying high-frequency electric field.

A body structure of the first sub-alignment layer 1021 further includes at least any one of a fluorine-free/fluorinated copolymer, a siloxane-containing branched chain, or an alkyl group. Optionally, the first sub-alignment layer 1021 may include a fluorine element, a fluorine-free/fluorinated copolymer, a siloxane-containing branched chain, and an alkyl group. In the embodiments of the present disclosure, when the above fluorine element is provided, it may be done by fluorine atom doping, so that the body structure of the first sub-alignment layer includes the fluorine element.

In the embodiments of the present disclosure, the fluorinated copolymer may include any one of polytetrafluoroethylene, tetrafluoroethylene-hexafluoropropylene copolymers, or polydifluorochloroethylene, while the siloxane-containing compound is mainly a class of compounds having a silicon-oxygen-silicon bond as a skeleton, and specifically, may include proposiloxane, cyclobutylsiloxane, hexamethyldisiloxane, or the like. Further, the alkyl group may include a methyl group, an ethyl group, an n-propyl group, an isopropyl group, or the like, and when provided, may be done according to different substances.

Further, since the first sub-alignment layer 1021 is configured to mainly act on the charges, a molecular gap is further provided in the body structure of the first sub-alignment layer 1021. That is, there is a molecular gap in a corresponding molecular chain of the first sub-alignment layer 1021 through which excess charges are effectively acted upon.

In the embodiments of the present disclosure, when the second sub-alignment layer 1022 is provided, the second sub-alignment layer 1022 is in direct contact with the liquid crystal material, and when a voltage is applied thereto, the second sub-alignment layer 1022 aligns the liquid crystals according to the varying high-frequency electric field. Thus, the panel illuminates normally for display.

The second sub-alignment layer 1022 includes a fluorine element therein. Meanwhile, in order to ensure the alignment effect of the second sub-alignment layer, the composition of the second sub-alignment layer 1022 can be similar to the structure of the liquid crystal material in the liquid crystal layer provided on the second sub-alignment layer 1022, so as to achieve better matching with liquid crystals, and paired with fast responsive liquid crystals, to improve the overall performance of the panel.

In the embodiments of the present disclosure, when the first sub-alignment layer 1021 and the second sub-alignment layer 1022 are provided, a material of the first sub-alignment layer 1021 may include any one of

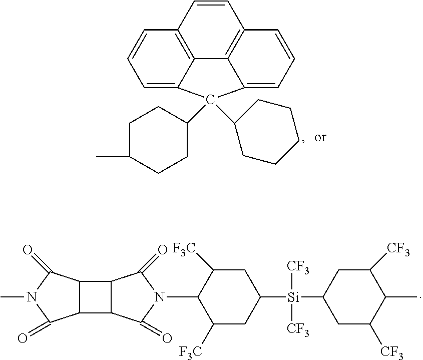

A material of the second sub-alignment layer 1022 may include:

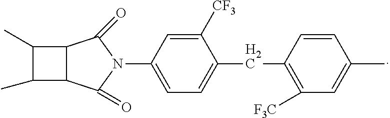

Thus, the liquid crystal alignment layer provided in the embodiments of the present disclosure is obtained.

Further, in the embodiments of the present disclosure, since the second sub-alignment layer and the first sub-alignment layer are mainly different in function, a film thickness of the first sub-alignment layer 1021 is greater than a film thickness of the second sub-alignment layer 1022. By improving the film thicknesses of the two sub-alignment layers, the effects of their functioning are further improved.

Specifically, a ratio between the film thickness of the first sub-alignment layer 1021 and the film thickness of the second sub-alignment layer 1022 is set to 2.0-4.5. Optionally, the film thickness of the second sub-alignment layer 1022 is set to 0.5 um-1.2 um, and correspondingly, the film thickness of the first sub-alignment layer 1021 is set to 1 um-5.4 um. Specifically, the film thickness of the second sub-alignment layer 1022 is set to 1 um, and the film thickness of the first sub-alignment layer 1021 is set to 2.5 um. At this point, a thickness ratio of the first sub-alignment layer 1021 to the second sub-alignment layer 1022 is 2.5. This ensures that while the alignment layer has a good alignment effect on liquid crystals, it can also better release charges generated at high frequencies through the first sub-alignment layer 1021 to meet high-frequency requirements and improve the overall performance of the panel.

Further, referring to the structure in FIG. 1, in the embodiments of the present disclosure, when the liquid crystal layer 103 of the liquid crystal display panel is provided, liquid crystal molecules 1031 are provided in the liquid crystal layer 103. To meet the requirements of the high-frequency display panel, the liquid crystal molecules 1031, when provided, may include any one of the following liquid crystal materials:

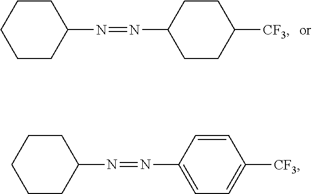 [SMILES: FC(F)(F)C1CCC(N=NC2CCCCC2)CC1 ; FC(F)(F)c1ccc(N=NC2CCCCC2)cc1]

Specifically, when the above liquid crystal molecules 1031 are provided, the spatial volume of each of the liquid crystal molecules 1031 is relatively small. When being acted upon by a varying high-frequency control signal, the liquid crystal molecules 1031 of small spatial volume can rotate relatively quickly, and in turn change synchronously with the high-frequency electric field, thereby achieving a relatively fast response speed.

In the embodiments of the present disclosure, when the liquid crystal molecules 1031 are provided, the spatial volume of each of the liquid crystal molecules 1031 is relatively small, for example, the lengths of the long axes corresponding to the liquid crystal molecules 1031 are relatively short, and a length-to-diameter ratio of the liquid crystal molecules 1031 can be set to 1.1-1.5. Meanwhile, the long axes of the liquid crystal molecules 1031 are not easy to bend. When the liquid crystal molecules 1031 rotate, the long axes of the liquid crystal molecules 1031 can respond quickly, thereby improving effects of the functioning of the liquid crystal layer.

Further, a molecular end of each of the liquid crystal molecules 1031 further includes a polar group. Specifically, the polar group may include any one of a hydroxyl group, a carboxyl group, an amino group, an amido group, or the like, and details are not repeated herein.

As shown in Table 1, Table 1 is an experimental performance parameter of the display panel provided in the embodiments of the present disclosure. In the embodiments of the present disclosure, the first sub-alignment layer 1021 and the second sub-alignment layer 1022 are prepared by the above method, where the liquid crystal alignment layer provided in the display panel in the following embodiment is provided using the structures and parameters in the embodiments of the present disclosure. Specifically, the first sub-alignment layer 1021 includes characteristics such as fluorine atom doping, alkylation, a fluorine-free/fluorinated copolymer, a siloxane-containing branched chain, and molecular gaps, etc. Meanwhile, in the second sub-alignment layer 1022, a fluorine element is introduced into the polyimide body material of the second sub-alignment layer 1022, and the structure of the second sub-alignment layer 1022 is similar to that of the liquid crystal molecules.

Further, the dielectric constant of the first sub-alignment layer 1021 corresponding to the above-mentioned characteristics is 2.4, and the dielectric constant of the second sub-alignment layer 1022 is 3.4. And the liquid crystal layer includes the liquid crystal molecules 1031 which are also provided in the embodiments of the present disclosure. The first sub-alignment layer 1021, the second sub-alignment layer 1022, and the liquid crystal layer constitute a cell, finally forming the display panel in the embodiments of the present disclosure. The performance of the display panel is measured and the data in Table 1 is obtained.

TABLE 1
Response times of liquid crystal display
panels at different frequencies

| | Response | Frequency/Hz | | | | | | |
|---|---|---|---|---|---|---|---|---|
| Product | time/ms | 144 | 175 | 240 | 480 | 960 | 1920 | 3840 |
| Product 1 | Time t1 | 26 | 30 | 41 | 58 | 76 | 99 | 116 |
| Product 2 | Time t2 | 4 | 6 | 12 | 20 | 28 | 36 | 45 |

In the above Table 1, the product 1 is a liquid crystal display panel provided in the related art, and the product 2 is the liquid crystal display panel provided in the embodiments of the present disclosure. The performance under test is mainly the response times corresponding to product 1 and product 2 at different frequencies. Specifically, the longer the response time of a display panel is, the longer the reaction time between an alignment layer and a liquid crystal layer of the display panel and the lag of signals are. However, if the response time of the display panel is short, it indicates that the display panel can respond to a varying high-frequency signal in a very short time, and is able to change synchronously with the high-frequency signal, thereby effectively ensuring the display effect of the panel.

From the above experimental results, it can be seen that the response times of product 1 and product 2 are relatively short under a low-frequency signal of 144 Hz, while the response times of product 1 and product 2 are longer under a high-frequency signal of 3840 Hz. However, under a same frequency, the response time of the product 2 is significantly less than the response time of the product 1. That is, the liquid crystal display panel provided in the embodiments of the present disclosure has a faster response speed.

Meanwhile, the response time of the product 1 is increased from 26 ms to 116 ms while the response time of the product 2 is increased from 4 ms to 45 ms when a low frequency of 144 Hz is increased to a high frequency of 3840 Hz. Although the response times of both products at high frequencies are increased, the increased values of the response times of the product 2 are much smaller than the increased values of the response time of the product 1. Therefore, the liquid crystal display panel provided in the embodiments of the present disclosure has a faster response speed at high frequencies, thereby effectively improving the display effect and the overall performance of the liquid crystal display panel.

Further, in the embodiments of the present disclosure, the liquid crystal display panel may be applied to any product or component having a function of high-frequency display or touch control, such as a computer, electronic paper, display, notebook computer, and digital photo frame, and a specific type thereof is not specifically limited.

To sum up, a liquid crystal alignment layer, a liquid crystal molecule, and a liquid crystal display panel according to the embodiments of the present disclosure have been described in detail above, and the principles and embodiments of the present disclosure have been described by using specific examples. The description of the above embodiment is merely intended to help understand the technical solution and the core idea of the present disclosure. Although the present disclosure has been described in terms of preferred embodiments, the foregoing preferred embodiments are not intended to limit the present disclosure. Those skilled in the art will be able to make various changes and modifications without departing from the spirit and scope of the present disclosure, and therefore the scope of the present disclosure is based on the scope defined in the claims.

What is claimed is:

1. A liquid crystal alignment layer comprising:
a first sub-alignment layer;
a second sub-alignment layer disposed on the first sub-alignment layer and on a side adjacent to a liquid crystal layer;
wherein a dielectric constant of the second sub-alignment layer is greater than a dielectric constant of the first sub-alignment layer.

2. The liquid crystal alignment layer of claim 1, wherein the dielectric constant of the first sub-alignment layer is set to 2.0-2.5 and the dielectric constant of the second sub-alignment layer is set to 2.8-4.5.

3. The liquid crystal alignment layer of claim 1, wherein a body structure of the first sub-alignment layer and a body structure of the second sub-alignment layer each comprise one of polyimide or polyimide acid; and
wherein the body structure of the first sub-alignment layer and the body structure of the second sub-alignment layer further comprise a fluorine element.

4. The liquid crystal alignment layer of claim 3, wherein the body structure of the first sub-alignment layer further comprises at least any one of a fluorine-free/fluorinated copolymer, a siloxane-containing branched chain, or an alkyl group.

5. The liquid crystal alignment layer of claim 1, wherein a material of the first sub-alignment layer comprises any one of 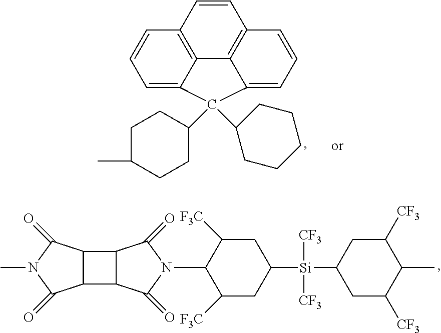
and a material of the second sub-alignment layer comprises:

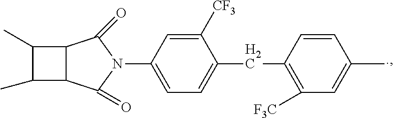

6. The liquid crystal alignment layer of claim 1, wherein a film thickness of the first sub-alignment layer is greater than a film thickness of the second sub-alignment layer.

7. The liquid crystal alignment layer of claim 1, wherein a ratio of the film thickness of the first sub-alignment layer to the film thickness of the second sub-alignment layer is set to 2.0-4.5.

8. A liquid crystal molecule, wherein a structural formula of the liquid crystal molecule comprises any one of

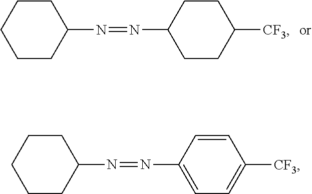 [SMILES: FC(F)(F)C1CCC(N=NC2CCCCC2)CC1 ; FC(F)(F)c1ccc(N=NC2CCCCC2)cc1]

9. The liquid crystal molecule of claim 8, wherein a molecular end of the liquid crystal molecule further comprises a polar group.

10. A liquid crystal display panel, comprising:
a first substrate;
a liquid crystal layer comprising a plurality of liquid crystal molecules, the liquid crystal layer being disposed on the first substrate; and
a second substrate disposed on the liquid crystal layer;
wherein the liquid crystal display panel further comprises liquid crystal alignment layers disposed on a side of the liquid crystal layer adjacent to the first substrate and on a side of the liquid crystal layer adjacent to the second substrate respectively, each of the liquid crystal alignment layers comprising a first sub-alignment layer; a second sub-alignment layer disposed on the first sub-alignment layer and on a side adjacent to the liquid crystal layer; wherein a dielectric constant of the second sub-alignment layer is greater than a dielectric constant of the first sub-alignment layer.

11. The liquid crystal display panel of claim 10, wherein the dielectric constant of the first sub-alignment layer is set to 2.0-2.5 and the dielectric constant of the second sub-alignment layer is set to 2.8-4.5.

12. The liquid crystal display panel of claim 10, wherein a body structure of the first sub-alignment layer and a body structure of the second sub-alignment layer each comprise one of polyimide or polyimide acid; and
wherein the body structure of the first sub-alignment layer and the body structure of the second sub-alignment layer further comprise a fluorine element.

13. The liquid crystal display panel of claim 12, wherein the body structure of the first sub-alignment layer further comprises at least any one of a fluorine-free/fluorinated copolymer, a siloxane-containing branched chain, or an alkyl group.

14. The liquid crystal display panel of claim 10, wherein a material of the first sub-alignment layer comprises any one of 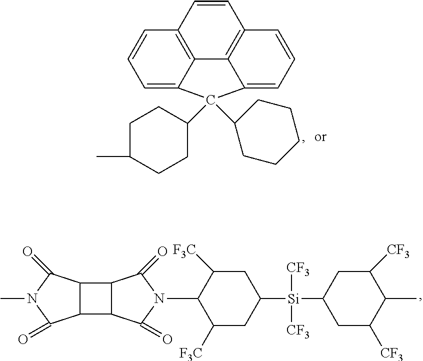
and a material of the second sub-alignment layer comprises:

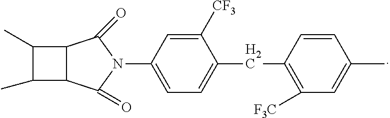

15. The liquid crystal display panel of claim 10, wherein a film thickness of the first sub-alignment layer is greater than a film thickness of the second sub-alignment layer.

16. The liquid crystal display panel of claim 10, wherein a ratio of the film thickness of the first sub-alignment layer to the film thickness of the second sub-alignment layer is set to 2.0-4.5.

17. The liquid crystal display panel of claim 10, wherein each of the plurality of liquid crystal molecules having a structural formula comprising any one of

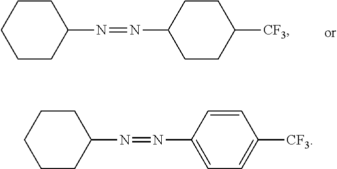 [SMILES: FC(F)(F)C1CCC(N=NC2CCCCC2)CC1 ; FC(F)(F)c1ccc(N=NC2CCCCC2)cc1]

18. The liquid crystal display panel of claim 17, wherein a molecular end of the liquid crystal molecule further comprises a polar group.

19. The liquid crystal display panel of claim 11, wherein each of the plurality of liquid crystal molecules having a structural formula comprising any one of

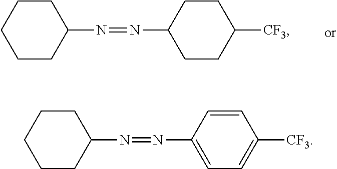 [SMILES: FC(F)(F)C1CCC(N=NC2CCCCC2)CC1 ; FC(F)(F)c1ccc(N=NC2CCCCC2)cc1]

20. The liquid crystal display panel of claim 19, wherein a molecular end of the liquid crystal molecule further comprises a polar group.
